(19) United States
(12) Patent Application Publication
(10) Pub. No.: US 2026/0300899 A1
(43) Pub. Date: Oct. 1, 2026

(54) SUPPLY CHAIN TRACKING AND MANAGEMENT SYSTEM AND RELATED METHODS

(71) Applicant: Dane Technologies, Inc., Maple Grove, MN (US)

(72) Inventor: Dan Johnson, Medina, MN (US)

(21) Appl. No.: 19/569,479

(22) Filed: Mar. 17, 2026

Related U.S. Application Data
(60) Provisional application No. 63/772,959, filed on Mar. 17, 2025.
(60) Provisional application No. 63/990,037, filed on Feb. 24, 2026.

(51) Int. Cl. G06Q 10/0833

(52) U.S. Cl. CPC G06Q 10/0833

(57) ABSTRACT

A supply chain tracking and management system includes a processor, a database, client computers, autonomous vehicles, legacy management systems, and data collection portals distributed across supply chain locations. Product, pallet, and location information can be collected during receipt, storage, movement, and shipment to track a product from origin to destination. The processor can create and maintain a digital representation, such as a digital twin map, of a facility in a common coordinate framework that stores locations of products, pallets, and vehicles and provides a common spatial reference for autonomous equipment. Autonomous inventory tracking vehicles can update the digital representation during operation. The system can also maintain a location-aware chain-of-custody record and analyze collected information to identify inventory conditions requiring attention.

### CROSS-REFERENCE TO RELATED APPLICATION(S)

This application claims the benefit under 35 U.S.C. § 119(e) to U.S. Provisional Application 63/772,959, filed Mar. 17, 2025 and entitled “Supply Chain Tracking and Management System and Related Methods,” and also claims priority to U.S. Provisional Application 63/990,037, filed Feb. 24, 2026 and entitled “Autonomous Vehicle for Inventory Tracking and/or Transport and Related Systems and Methods,” both of which are hereby incorporated herein by reference in their entireties.

### FIELD

The various embodiments herein relate to tracking and management of items in a supply chain, from manufacturing to delivery to the end user, and systems and methods relating thereto.

### BACKGROUND

Warehouse and supply chain operations can rely on management systems to maintain information regarding products, pallets, boxes, and other items. In many cases, however, such systems do not maintain sufficiently accurate or current information regarding the physical location and status of those items within a facility. As a result, receiving, put away, inventory, picking, and shipping functions may involve manual verification, periodic scans, cycle counts, or other labor-intensive processes.

In some environments, item records may identify an expected storage location or other system location for a pallet or product, but such information may not reliably correspond to the actual physical position of the item within the facility. This can make it difficult to confirm whether an item is present at an intended location, whether an open location is available, or whether the correct item is being moved, picked, or shipped. It may also be difficult to maintain current information regarding the quantity or condition of items as the items move through receiving, storage, and shipping operations.

In addition, facilities may use vehicles, scanning devices, and legacy software systems that operate with different maps, interfaces, or data structures. This can make it more difficult to correlate item information with physical space and to coordinate activity within the facility. Accordingly, a need remains for improved systems and methods for tracking items within a facility and across a supply chain.

In some environments, a system record may indicate that a pallet or other item should be at a particular warehouse location, while the pallet or other item is in fact missing, misplaced, or replaced by a different item. In such circumstances, personnel may be required to search the facility to determine whether the expected item is present, where the item is actually located, or whether an incorrect item is positioned for picking or shipment. In addition, inventory verification may involve manual cycle counts, manual scanning, or use of lifting equipment to inspect elevated storage locations, which can be labor intensive, time consuming, and difficult to perform on a frequent basis. These and other issues can reduce inventory visibility and increase the likelihood of inefficiencies in receiving, storage, picking, and shipping operations.

There is a need in the art for an improved supply chain tracking and management system.

### BRIEF SUMMARY

Discussed herein are various systems and methods that can be used to track products, maintain location information, and coordinate autonomous equipment within a facility.

In Example 1, a supply chain tracking and management system comprises a processor connected to a network. The system also comprises a database connected to the processor. The system also comprises at least one client computer connected to the processor via the network. The system also comprises at least one autonomous inventory tracking vehicle at each location connected to the processor. The system also comprises at least one autonomous product transport vehicle at each location connected to the processor. The system also comprises at least one legacy management system at each location connected to the processor. The system also comprises at least one data collection portal at each location connected to the processor. Any product or pallet shipped through a supply chain can be tracked and managed from its point of origin to its final destination via the system.

Example 2 relates to the system according to Example 1, wherein the processor is configured to create and maintain a digital representation of a facility.

Example 3 relates to the system according to Example 2, wherein the digital representation comprises a digital twin map that serves as a single version of truth for the facility.

Example 4 relates to the system according to Example 2, wherein the digital representation stores a physical location of a tracked asset and a vehicle within a common coordinate framework.

Example 5 relates to the system according to Example 4, wherein the common coordinate framework comprises shared x, y, and z coordinates for the facility.

Example 6 relates to the system according to Example 5, wherein the processor is configured to provide the shared x, y, and z coordinates to the autonomous inventory tracking vehicle and the autonomous product transport vehicle as a common spatial reference.

Example 7 relates to the system according to Example 6, further comprising an additional autonomous platform connected to the processor, wherein the processor is configured to provide the common spatial reference to the additional autonomous platform.

Example 8 relates to the system according to Example 2, wherein the autonomous inventory tracking vehicle is configured to collect, from one or more machine-readable identifiers associated with tracked items, data usable to update the digital representation during routine inventory operation.

Example 9 relates to the system according to Example 8, wherein the autonomous inventory tracking vehicle is configured to collect identifying information from front-facing inventory and from inventory disposed behind the front-facing inventory.

Example 10 relates to the system according to Example 1, wherein the data collection portal comprises a mobile data collection portal configured to be positioned at a selected dock-side location to scan a product or pallet during unloading.

Example 11 relates to the system according to Example 1, wherein the processor is configured to maintain a location-aware chain-of-custody record for the product or pallet from receipt to departure.

Example 12 relates to the system according to Example 11, wherein the processor is configured to selectively share at least a portion of the location-aware chain-of-custody record with an authorized supply-chain participant.

Example 13 relates to the system according to Example 1, wherein the processor is configured to analyze information maintained in the database to identify an inventory condition requiring attention.

In Example 14, a system for coordinating autonomous equipment in a facility comprises a processor connected to a network. The system also comprises a database connected to the processor. The system also comprises at least one client computer connected to the processor via the network. The system also comprises at least one autonomous vehicle in the facility connected to the processor. The system also comprises at least one data collection device in the facility connected to the processor. The system also comprises software executed by the processor and configured to create and maintain a digital twin map of the facility in a common coordinate framework based at least in part on data collected within the facility, and to provide the digital twin map as a common spatial reference for the at least one autonomous vehicle within the facility.

Example 15 relates to the system according to Example 14, wherein the digital twin map serves as a single version of truth for the facility.

Example 16 relates to the system according to Example 14, wherein the common coordinate framework comprises shared x, y, and z coordinates for the facility.

Example 17 relates to the system according to Example 14, wherein the at least one data collection device is configured to collect, from one or more machine-readable identifiers associated with tracked items, data usable to update the digital twin map during operation in the facility.

In Example 18, a method of tracking a product along a supply chain comprises collecting information about the product at a first location via a first data collection portal, wherein the information comprises product information, pallet information, and location information. The method also comprises shipping the product to a second location. The method also comprises collecting information about the product at the second location via a second data collection portal. The method also comprises actuating an autonomous device to transport the product to a space at the second location. The method also comprises actuating the autonomous device to later transport the product from the space to a loading dock at the second location. The method also comprises collecting information about the product at the second location via the second data collection portal. The method also comprises shipping the product to a third location. The method also comprises collecting information about the product at the third location via a third data collection portal. The method also comprises actuating an autonomous device to transport the product to a space at the third location.

Example 19 relates to the method according to Example 18, further comprising creating and maintaining a digital twin map for at least the second location, the digital twin map storing a physical location of the product within a common coordinate framework, wherein the digital twin map is updated using data obtained from one or more machine-readable identifiers associated with the product.

Example 20 relates to the method according to Example 18, further comprising maintaining a location-aware chain-of-custody record for the product along the supply chain based on the collected information.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1 is a schematic diagram of a network-based system, according to one embodiment.

FIG. 2A is a perspective view of an autonomous data collection device, according to one embodiment.

FIG. 2B is a perspective view of a data collection cart for use with the device of FIG. 2A, according to one embodiment.

FIG. 2C is a perspective view of a cart for use with the device of FIG. 2A, according to one embodiment.

FIG. 3A is a perspective view of an autonomous powered vehicle, according to one embodiment.

FIG. 3B is a perspective view of an autonomous forklift, according to one embodiment.

FIG. 3C is a perspective view of an autonomous pallet jack, according to one embodiment.

FIG. 4A is a perspective view of an autonomous cart moving device having data collection sensors, according to one embodiment.

FIG. 4B is a perspective view of an autonomous robotic device having sensors, according to one embodiment.

FIG. 5A is a perspective view of a product data collection portal, according to one embodiment.

FIG. 5B is a front view of the product data collection portal of FIG. 5A, according to one embodiment.

FIG. 5C is a side view of the product data collection portal of FIG. 5A, according to one embodiment.

FIG. 5D is a perspective view of the product data collection portal of FIG. 5A having a pallet positioned within the opening of the portal, according to one embodiment.

FIG. 6 is a flowchart of a method of tracking and managing one or more products or pallets, according to one embodiment.

FIG. 7 is a perspective view of an autonomous vehicle in a warehouse environment, according to one embodiment.

FIG. 8A is a front view of an autonomous inventory robot and respective fields of view of curtain sensors, according to one embodiment.

FIG. 8B is an isometric view of an autonomous inventory robot and respective fields of view of certain sensors, according to one embodiment.

FIG. 9A is a front view of an autonomous inventory robot and respective fields of view of certain sensors, according to one embodiment.

FIG. 9B is an isometric view of an autonomous inventory robot and respective fields of view of certain sensors, according to one embodiment.

### DETAILED DESCRIPTION

The various embodiments herein relate to a system that provide seamless tracking and management of product/item shipping along a supply chain.

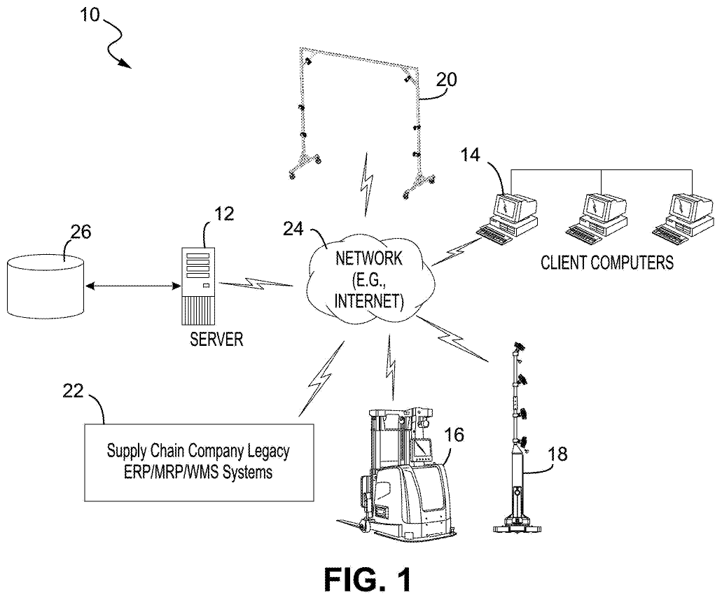

FIG. 1 depicts a schematic diagram of one embodiment of a network-based system 10 for tracking and/or managing one or more products or other items in a supply chain, along with other information related to those products, including the one or more sites through which the one or more products may travel, the one or more companies that own or are otherwise responsible for the one or more products, etc. The system 10 in this exemplary implementation can include a server 12, one or more client computers 14, autonomous product moving equipment (such as an autonomous forklift) 16, autonomous data collection vehicles 18, mobile product data collection portals 20, and legacy management systems 22, all connected through a network 24 (such as, for example, the internet). The client computers 14 can be located at one or more of the various sites along the supply chain or could be located at other locations, such as third-party shipping or distribution company sites. “Client computers” 14 as used herein shall mean any known type of processor or computer and can also be referred to as site processors 14 or site computers 14. The system 10 allows any shipping entity or other enterprise to track and/or manage products or other goods at one or more of multiple sites along the supply chain.

As further shown in FIG. 1, one of ordinary skill understands that the server 12 can also be a cloud-based server 12, according to certain embodiments, and that any portion of the overall system 10 can utilize the cloud. Further, in one implementation, the server 12 is in communication with at least one database 26. According to one embodiment, the asset database 26 contains information regarding a product or item, or a group of products/items (such as on a pallet), such as individual product identification, pallet identification, product description, pallet description, product location, pallet location, or any other kind of information relating to a product or a pallet (or other transport container). One of skill in the art understands that the term “product” as used herein is intended to mean any product, item, or good that can be shipped from one location to another in a supply chain. Further, one of skill in the art understands that the term “pallet” as used herein is intended to mean any grouping of products or transport mechanism or container for such products.

Alternatively, various embodiments of the system described herein can have separate databases for different kinds of product and/or pallet information such as a product/pallet database based on type of product, a product/pallet database based on the entity that owns the products/pallets, etc. In a further alternative, all the data is maintained in a single database.

It is understood that the server or central processor 12 (also referred to herein as an “enterprise processor”) can be any computer known to those skilled in the art. In one embodiment, the central processor 12 includes a website hosted in at least one or more computer servers. It is understood that any system disclosed herein may have one or more such server 12 and that each server may comprise a web server, a cloud server, a database server and/or application server, any of which may run on a variety of platforms.

According to one embodiment, the enterprise processor or processors 12 comprise a central processor unit (“CPU”) and main memory, an input/output interface for communicating with various databases, files, programs, and networks (such as the Internet), and one or more storage devices. The storage devices may be disk drive devices or CD-ROM devices or cloud-based storage. The enterprise processor 12 may also have a monitor or other screen device and an input device, such as a keyboard, a mouse, or a touch sensitive screen. Some non-limiting commercial examples of servers that could be used with various embodiments disclosed herein include Dell 2950, Sun Solaris, HP 9000 series, and IBM x3000 series.

In one implementation, the central processor 12 includes software programs, modules, or instructions that run on the server-side to process requests and responses from a client computer 14. These software programs or instructions send information to the client computer 14, perform calculation, compilation, and storage functions, transmit instructions to the client computer 14 or to one or more pieces of equipment, and generate reports. It is understood that any embodiment of the systems disclosed herein that provide for data collection, storage, tracking, and managing can be controlled using software associated with the system. It is further understood that the software utilized in the various embodiments described herein may be a software application or applications that are commercially sold and normally used by those skilled in the art or it may be a specific application or applications coded in a standard programming language.

It is further understood that the software can be any known software for use with the systems described herein to track, calculate, and manage the various parameters as described herein. For example, as described in further detail herein, various embodiments of the systems described herein could have any one or more of software for tracking the information discussed above relating to one or more products, pallets, locations, or companies.

It is also understood that the software programs, instructions, or modules used to operate the system 10 can also include such programs or modules associated with any of the components coupled to the system 10, including one or more of the client computers 14, one or more of the autonomous vehicles/robots 16,18, one or more of the legacy systems 22 as discussed in further detail below, or any other potential components coupled to the system 10 as disclosed or contemplated herein.

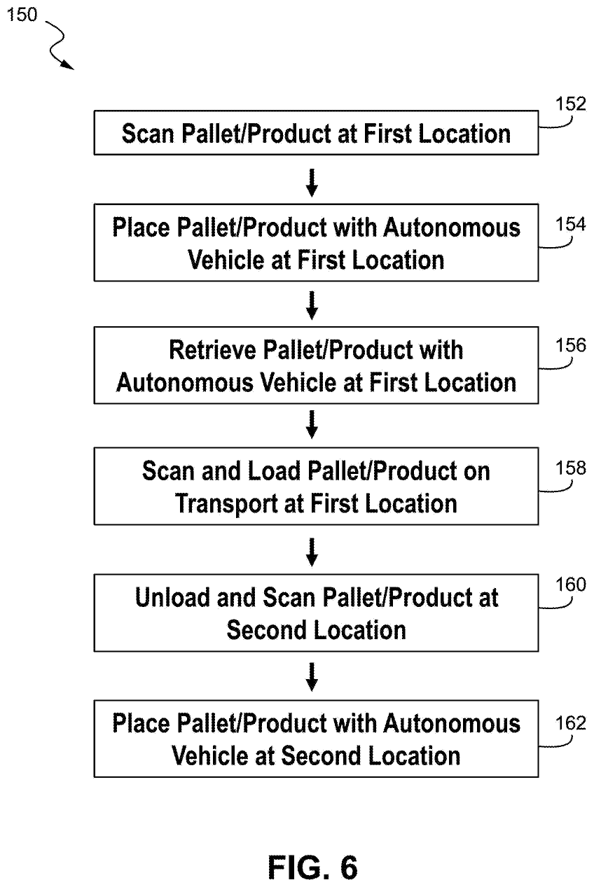

The software programs or modules as disclosed or contemplated herein can include any such software program or module for racking one or more products or pallets along a supply chain path from its original location to its final destination. That is, the software can operate with the system 10 to perform the various functions described below, such as described in further detail in FIG. 6 and elsewhere herein. As such, the software programs or modules can operate to communicate with the various components of the system 10, including the client computers 14, the product moving devices/vehicles 16, the data collection devices/vehicles 18, the data collection portals 20, and the legacy systems 22, and any other components that can be coupled to the system 10 as disclosed or contemplated herein to track and move one or more products/boxes/cases/pallets from a point of origin to a final destination, with one or more stops at one or more distribution centers or the like (or no stops) along the way. As such, the various steps as set forth in FIG. 6 and the related description below can be performed by one or more software programs or modules present in the system 10 or in any of the components thereof (or a combination of such programs/modules).

The central processor 12 allows access by the client processor 14 to various network resources. In one embodiment, the central processor 12 also has access, via the network 24 or some other communication link, to external data sources that may be used to keep the information in the server current. In one implementation, a number of site computers 14 may be connected to the server 12 at any given time, and therefore a number of an enterprise's facilities or locations may utilize the system simultaneously.

According to one embodiment, the database (or databases) 26 can be of any type generally known in the art. The database 26 can be integral to the central processor 12, cloud based, or it can be accessible to the central processor 12 through a computer network or other suitable communication link. In one embodiment, the database 26 is comprised of a plurality of database servers, some of which are integral to the central processor 12, and some that are located remotely from the central processor 12. In addition to any known cloud-based database, some non-limiting commercial examples of databases that could be used with various embodiments disclosed herein include Oracle 9i, Oracle 10g, Microsoft SQL Server, PostSQL, and Ingress.

The database 26 can serve as the input to and information storage for the management and tracking system 10, which processes the information as described below and generates any one or more of notifications, reports, predictive analysis, suggested actions, and/or instructions to a user, an autonomous piece of equipment, or a third party system.

According to certain embodiments, each piece of autonomous product moving equipment 16 and/or each autonomous data collection vehicle 18 (and/or combination product moving and data collection vehicles) at each location—such as warehouses—in the supply chain can be connected to the system 10 via the network 24. Each autonomous piece of equipment 16 and/or vehicle 18 at a site can be wirelessly coupled to the network 24 directly via an interface such as, for example, a transceiver, or any other known component or mechanism for allowing such connection. Alternatively, each piece of equipment 16 and/or vehicle 18 at a particular site can be wirelessly coupled to one or more local client computers 14 at that location via a local area network, and thus can be coupled to the network 24 via the computers 14. In a further alternative, each piece of equipment 16 and/or vehicle 18 can be connected to the network 24 and thus the system 10 via any known fashion. Alternatively, any particular site might have only product moving devices/vehicles 16, only data collection vehicles 18, or only combination moving/collection vehicles/devices that are connected to the system 10, or any combination thereof.

The autonomous product moving equipment 16 can be any known autonomous device or vehicle for moving products, pallets, or other containers within a site, such as a warehouse. For example, the autonomous product moving device/vehicle 16 can be an autonomous forklift 16. Alternatively, the device/vehicle 16 can be an autonomous pallet jack. In a further alternative, the autonomous product moving device/vehicle 16 can be any such known device or vehicle that can operate autonomously in a warehouse or other site environment to move products, pallets, or other containers within that space.

The autonomous data collection vehicle 18 can be any such known vehicle, including, for example, any of the autonomous data collection robots disclosed in U.S. patent application Ser. No. 16/928,993, U.S. patent application Ser. No. 18/600,879, and/or U.S. Provisional Application 63/756,513, all of which are hereby incorporated herein by reference in their entireties. Alternatively, the autonomous data collection vehicle 18 can be any other such known vehicle or robot for collection of information in a warehouse or other site environment to collect information about products, pallets, or other containers within that space.

In addition, one of ordinary skill understands that certain of the vehicles or devices that can be connected to the system 10 can be combination product moving and data collection vehicles or devices, such as those described in U.S. patent applications Ser. No. 16/928,993, Ser. No. 18/600,879, and 63/756,513, as discussed above and incorporated herein.

Further, in addition to the various autonomous vehicles and devices (such as the autonomous devices 16, 18 as described above and below), one of ordinary skill understands that the system 10 as described herein can operate through the use of non-autonomous equipment as well. That is, the various software programs/modules associated with the system 10 can communicate with one or more client computers 14 (such as a desk computer, a laptop, a smartphone, a pad, or an interface on a non-autonomous device/vehicle) at a specific location to perform the necessary data collection or to send instructions for movement of one or more products/boxes/cases/pallets as described herein. As such, while the system 10 can operate with autonomous vehicles/devices as described herein, every step as described herein (such as in FIG. 6 as discussed below) and every other function of the system 10 can also be performed through the use of non-autonomous equipment as well.

In accordance with certain embodiments, any one or more of the sites in the supply chain can also have one or more multi-sensor portals 20 at the location that can be used to collect data about one or more product or pallet by transporting the one or more product or pallet through the portal 20, as will be described in further detail below. According to some implementations, each portal 20 at each location-such as warehouses—in the supply chain can be connected to the system 10 via the network 24. That is, each portal 20 at a site can be wirelessly coupled to the network 24 directly via an interface such as, for example, a transceiver, or any other known component or mechanism for allowing such connection. Or every sensor on the portal 20 can have its own interface. Alternatively, each portal 20 at a particular site can be wirelessly coupled to one or more local client computers 14 at that location via a local area network, and thus can be coupled to the network 24 via the computers 14. In a further alternative, each portal 20 can be connected to the network 24 and thus the system 10 via any known fashion.

Various implementations of the system 10 can also be connected to one or more of a supply chain company's internal management systems 22. For example, the system 10 can be connected via the network 24 to a company's enterprise resource (“ERP”) system, a material requirements planning (“MRP”) system, a warehouse management system (“WMS”), or any other legacy system used by the company that can connect to the system 10. According to some implementations, the one or more systems 22 of the company in the supply chain can be connected to the system 10 via the network 24. That is, each system 22 of the company can be coupled directly to the network 24. Alternatively, each system 22 of the company can be coupled to or run from one or more local client computers 14, and thus can be accessed by the network 24 via the computers 14. In a further alternative, any one or more system 22 can be connected to the network 24 and thus the system 10 via any known fashion.

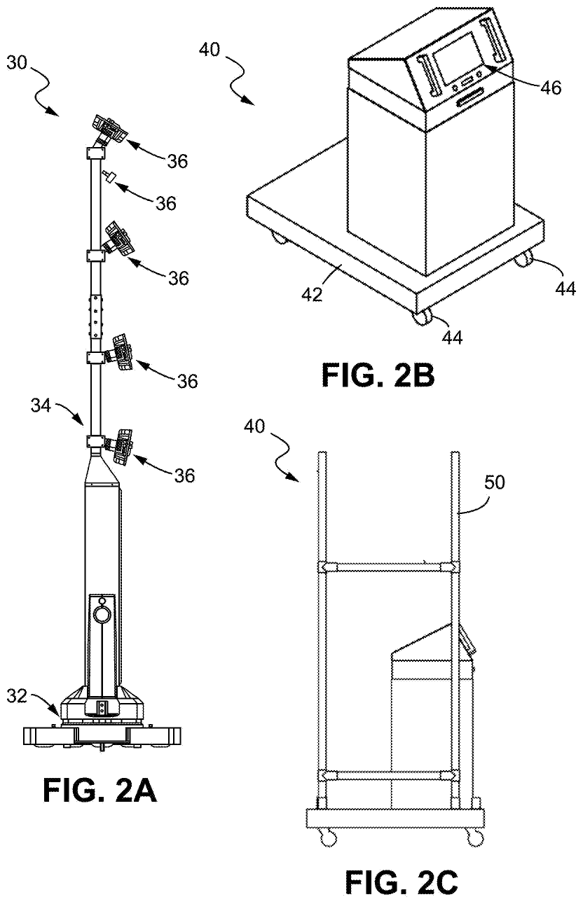

One embodiment of an autonomous data collection device 30 is depicted in FIG. 2A. The self-propelled and autonomous device 30 has a base 32 and a mast 34 extending vertically from the base 32, wherein the mast 34 has multiple sensors 36 attached thereto for the collection of information. The sensors 36 can include one or more cameras, sensors (such as, for example, one or more RFID sensors, lidar sensors, and/or any other type of data collection sensors), and/or any other sensors to collect information about the surroundings of the device 30. The term “sensor,” as used herein, is intended to mean any device or mechanism that can collect any type of data, including a camera, an RFID sensor, a barcode reader, a Bluetooth sensor, a Bluetooth low energy (“BLE”) sensor, a LIDAR sensor, or any other type of sensor or data collection device. In one embodiment, the autonomous device 30 as shown can be any of the device embodiments with similar mast as disclosed in U.S. Provisional Application 63/756,513, filed on Feb. 10, 2025, which is incorporated herein by reference above, and can operate in a similar fashion.

In another example, a basic configurable, non-self-propelled data collection cart 40 is depicted in FIG. 2B that can be coupled to a self-propelled, autonomous device according to any of the embodiments herein. The cart 40 can have a base 42, wheels 44 rotatably attached to the base 42, a user interface 46, and a processor (not shown) coupled to the user interface 46. The user interface 46 and processor (not shown) can, in certain embodiments, control the cart 40 and/or the information collection related thereto. It is understood that the cart 40 can also have various other components thereon depending on the desired functionality.

The on-board processor (not shown) is coupled to the server of the overall system (such as server 12 discussed above with respect to FIG. 1) via a wireless connection such that any information collected via the processor can be transmitted or otherwise transferred to the server. The information collected by the processor can include any information initially collected via the interface 46 and/or any sensors or data collectors (not shown) of any kind on the cart 40, depending on the variable configuration of the cart 40 as discussed in additional detail below. Further, it is understood that any information collected at the cart 40 in any way or via any device/component disclosed or contemplated herein is transferred to the on-board processor and/or to the server (such as server 12) in any known fashion such that software can process the information and then store that information as described elsewhere herein.

Another embodiment of the cart 40 is depicted in FIG. 2C, in which the cart 40 has a removable, adjustable scaffold (or “frames”) 50 that can be attached to the cart 40 to receive various components for use with the cart 40, including any of the sensors or other components discussed with respect to any of the other autonomous devices elsewhere herein or other structures. The various sensors and other data collection instruments can be removably attached to the scaffold 50 such that the selected instruments can perform the desired function of collecting information about the one or more products being tracked, as discussed elsewhere herein. For example, the instruments can include, but are not limited to, shelf-scanning and/or inventory cameras, a barcode reader, an RFID reader, and/or any other known sensor, detection device, or instrument for collecting information relating to items in a large area or retail or warehouse setting.

Further, the carts 40 as shown in FIGS. 2B and 2C can be any non-self-propelled data collection cart as disclosed in further detail in U.S. patent applications Ser. No. 16/928,993, Ser. No. 18/600,879, and/or U.S. Provisional Application 63/756,513, which are incorporated by reference above.

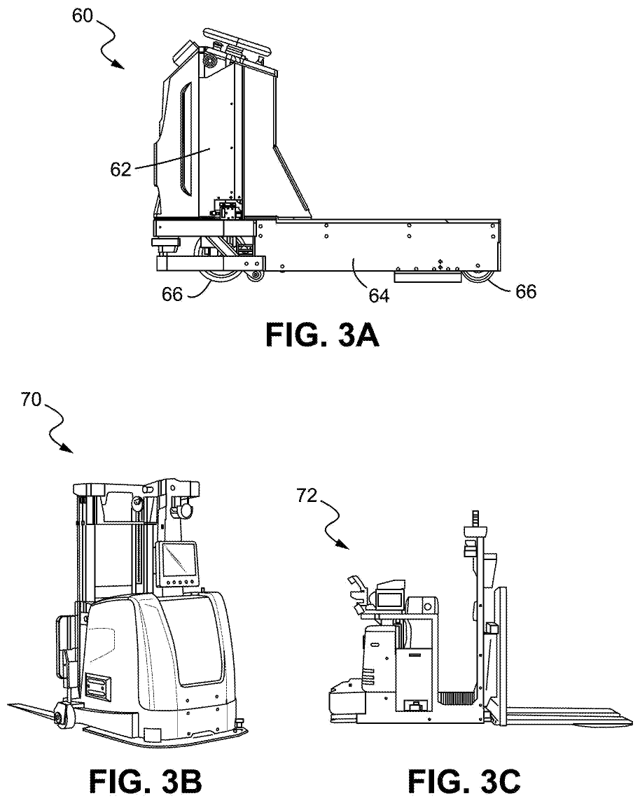

Various autonomous product moving devices can also be utilized in the system embodiments disclosed or contemplated herein. For example, certain such devices are shown in FIGS. 3A-3C. More specifically, FIG. 3A depicts an exemplary autonomous powered vehicle 60 having a body 62, wings (or “arms”) 64, wheels 66 rotatably coupled to the body 62 and the wings 64 as shown, and an optional steering wheel 68 for an operator to use when the vehicle 60 is in the non-autonomous mode. Further, FIG. 3B depicts a commercially-available autonomous forklift 70, while FIG. 3C depicts a commercially-available autonomous pallet jack 72. Any of these exemplary devices/vehicles as shown and any other known autonomous item-moving devices and/or vehicles can be used with the various system 10 implementations herein.

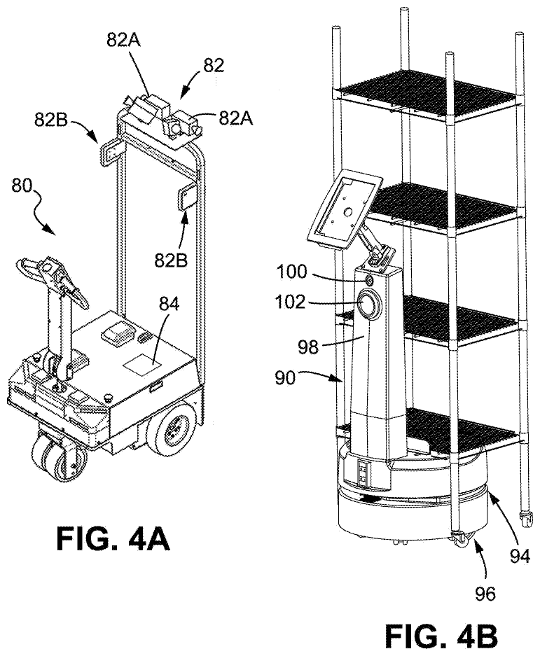

In addition, as noted above, various combination devices and/or vehicles can also be used with the various system embodiments herein. That is, certain devices can be used that perform both data collection and product transport. Two examples are depicted in FIGS. 4A and 4B, with FIG. 4A depicting an autonomous cart moving device 80 having data collection sensors 82 disposed thereon, while FIG. 4B depicts an autonomous robotic device 90 that can have sensors and can be used to move carts (e.g., 40, 92, etc.) and other items around a warehouse or other large space or building.

The autonomous vehicle 80 as shown in FIG. 4A, according to one embodiment, is a tracking vehicle 80 that is an autonomous transportation apparatus 80 having a data collection apparatus 82 disposed thereon. In this implementation, the collection apparatus 82 has four digital cameras 82A and two RFID readers 82B both attached to an extendable mast 84. Alternatively, the vehicle 80 can have any number of sensors of any type as described elsewhere herein for the collection of information about products or other items in the space through which the vehicle 80 traverses. Further, the vehicle 80 can have an on-board processor 84 coupled to the sensors 82. Further, the processor 84 can have software that processes the electronic images captured by the cameras 82A and enlarge or otherwise process the images to identify the information captured on the target items by the cameras 82A. Alternatively, the processor 84 can receive data from any of the sensors 82 that might be on the mast 84 and utilize that data as described in additional detail below to track, transport, and otherwise manage one or more products. For example, the processor 84 can be in wireless communication with the processor 12 of the system 10, such that the information collected by the sensors 82 of the vehicle 80 can be transmitted to the processor 12 and utilized by the system 10 to track, transport, and otherwise manage one or more products as described in additional detail elsewhere herein.

FIG. 4B shows another exemplary embodiment of an autonomous prime mover 90 that can track and move products within a warehouse or other large space. The prime mover 90 is a vehicle or transportation apparatus 90 substantially similar to the various other autonomous vehicles described in detail elsewhere herein. Some embodiments also include a cart 92 that can couple with the autonomous vehicle 90. The prime mover 90 has a base 94, a plurality of wheels 96 disposed on the bottom of the base 94, and a mast 98 disposed on the base 94. The base 94 can be configured to receive the cart 92 such that the cart 92 is attachable to the base 94. The mast 98 can include a variety of sensors, including, for example, a sensor 100 disposed near a top end of the mast 98 and at least one camera 102. Alternatively, the sensors 100 and/or camera 102 can be disposed anywhere on the mast 98. The positioning of the camera 102 and/or sensors 100 can be such that the camera 102 and/or sensors 100 can capture images and/or data in an area adjacent to the mast 98 within the field of view of the camera 102 and/or sensors 100. Alternatively, the mast 98 can have any other information collection device according to any of the other autonomous vehicle embodiments discussed above, including an RFID reader or the like. Further, the vehicle 90 can operate in a fashion similar to any of the vehicles described above to collect information about and track various items within a predetermined location.

Further, the vehicles 80, 90 as shown in FIGS. 4A and 4B can be any of the self-propelled, autonomous vehicles as disclosed in further detail in U.S. patent applications Ser. No. 16/928,993, Ser. No. 18/600,879, and/or U.S. Provisional Application 63/756,513, which are incorporated by reference above.

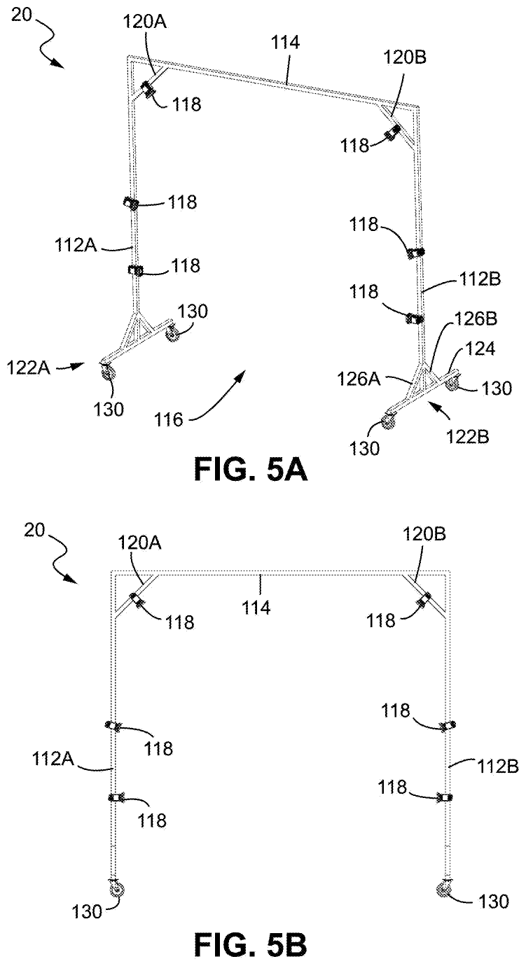

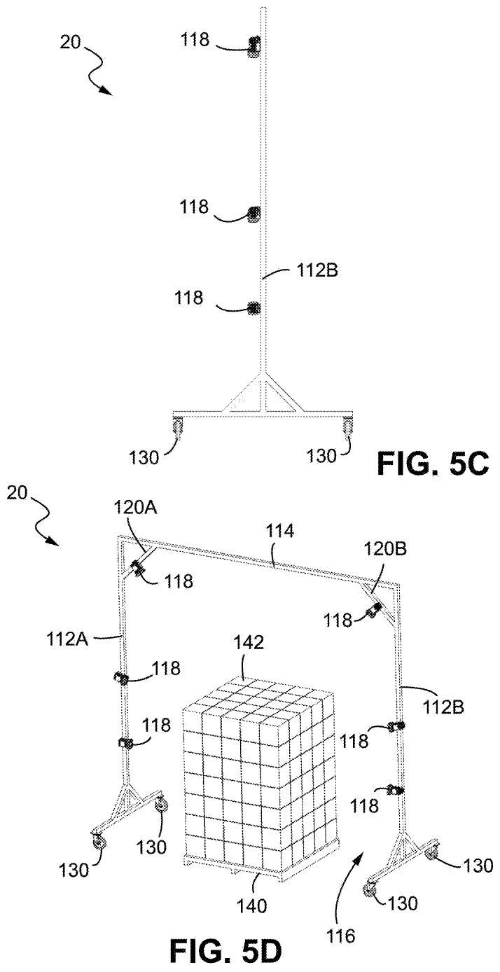

According to certain implementations, the system 10 can also include one or more product data collection portals 20 as mentioned above. As shown in FIGS. 5A-5D, the portal 20 in one exemplary embodiment has a frame 110 with two legs 112A, 112B and a horizontal crossbar 114 that extends between and is coupled to each of the legs 112A, 112B as shown such that the frame 110 defines an opening 116 through which items (such as products or pallets containing products) can pass. Further, the portal 20 has multiple sensors 118 attached to the frame 110. In the exemplary embodiment as shown, the portal 20 has 6 sensors 118. Alternatively, the portal 20 can have one, two, three, four, five, seven, eight, nine, ten, eleven, twelve, or any other number of sensors 118 attached to the frame 110. In certain implementations, the sensors 116 are all directed or “aimed” inward—toward the opening 116 defined within the frame 110—such that any object that is disposed within or passes through that opening 116 is scanned or otherwise captured by the each of the sensors 118.

In certain versions, the frame 110 can have angle supports 120A, 120B attached in each upper corner of the frame 110 such that one end of the support 120A, 120B is attached to one of the legs 112A, 112B and the other end is attached to the crossbar 114. In certain embodiments, including the version shown, a sensor 118 can be attached to each of the angle supports 120A, 120B. Further, the frame 110 can also have base supports 122A, 122B attached to the bottom of the legs 112A, 112B to provide stability and support to the frame 110. In the exemplary implementation depicted, as best shown in FIG. 5A, each base support 122A, 122B includes a horizontal base bar 124 and two angle supports 126A, 126B. Alternatively, the base supports 122A, 122B can be any known structure for providing sufficient support and stability to the frame 110 such that the frame 110 remains upright and vertically stable during use. Further, certain embodiments of the frame 110 can also have wheels 130 such that the portal 20 can be easily moved around in the space where it is being used. As shown, a swivel wheel 130 is disposed at each end of each base support 122A, 122B. Alternatively, each wheel 130 can be any type of wheel and can be attached to the frame 110 in any known configuration such that the portal 20 can be easily wheeled around the location.

In one embodiment, the sensors 118 can be any one or more of a camera, an RFID sensor, a LIDAR sensor, a barcode reader, a Bluetooth sensor, a BLE sensor, or any other known device for collecting information relating to any object passing through the opening 116.

In addition, each sensor 118 and/or the portal 20 itself is in wireless communication with the server 12 of the system via the network 24 such that information can be transmitted to and from the server 12. That is, either the portal 20 or each of the sensors 118 (or both) can have a transceiver or other mechanism that allows for communication with the server 12 via the network 24.

In use, according to certain implementations, a specific location—such as a distribution center, warehouse, etc.—can have one or more portals 20 that can be strategically positioned within the location such that it can be used to capture pallet and product information. For example, FIG. 5D depicts a pallet 140 of products 142 positioned within the opening 116 of the portal 20 such that the sensors 118 can collect various types of information about the pallet 140 and/or the products 142 disposed thereon. Thus, one or more portals 20 can be used at a location such as a loading dock to track every pallet and/or product as it arrives at the location and/or as it is loaded onto a truck or other vehicle for transport to another location. Thus, if each location through which a pallet/product passes has at least one portal 20, the portal(s) 20 can be used to monitor and track each product and/or pallet as it moves along the supply chain such that the system 10 is able to identify the location of the pallet/product as at a particular location or in transit from one location to another.

According to one embodiment, the system 10 can be used to track any one or more product and/or pallet across multiple locations. For example, in one exemplary version as shown in FIG. 6, a method of tracking and managing one or more products or pallets 150 is provided. First, the pallet or product is scanned at a first location (block 152). That is, an autonomous vehicle (such as any of the autonomous vehicles disclosed or contemplated above, including the forklift 16, the robot 18, the pallet fork 72, the vehicle 90 with a cart 92, or any other known autonomous vehicle or system) or a portal 20 can be used to scan, read, or otherwise collect information from the product and/or pallet. In one specific example, the first location can be a manufacturing plant, and the product/pallet can be scanned once the product(s) are manufactured and placed on a pallet. Alternatively, the first location can be any other type of location, such as a warehouse or distribution center in which the product/pallet is first being added to the system for tracking and management. The product/pallet information can be processed by an onboard processor on the vehicle/portal or can be transmitted to the system server 12 and further can be stored in the database 26. In certain embodiments, the information can also- or alternatively-be transmitted to a local server and/or a legacy system 22 at the specific location and further can be accessed by the system 10 from there.

The information collected from the product/pallet can be any of the following: a pallet identifier (such as a barcode based pallet identifier or “license plate”), pallet type, pallet dimensions, status of pallet (owned or leased), one or more product or box identifiers, product or box dimensions, company or owner of the product/pallet, information about the number of products or boxes on the pallet, whether the pallet is full, information about whether there is space for additional products or boxes, condition of the products/boxes (damage or undamaged, for example), or product expiration date, for example. Any other known parameters or information can also be collected. For certain pieces of information, that information can embedded in an RFID tag, a barcode, a hybrid tag, or any other type of information storage device. Alternatively, in various implementations, one or more of the sensors collecting the information can be one or more cameras that can be used to capture the information via LIDAR or some other similar technology. That is, the one or more cameras can capture the pallet type, the pallet dimensions, the product or box dimensions, the number of products or boxes on the pallet, whether the pallet is full, whether there is space for additional products or boxes, and/or the condition of the products/boxes.

Returning to FIG. 6, once the product/pallet is scanned, if it is not going to be immediately transported to the loading dock for shipping, the processor 12 can use the above information to place the product/pallet in an available space at the first location (block 154). That is, the system 10 can be configured to have the layout of the first location and further can have updated information about open spaces therein, as will be described in further detail below. As such, the processor 12 can actuate an autonomous vehicle (such as any of the vehicles disclosed or contemplated herein) to move the product/pallet to one of the open spaces. The processor 12 can be configured to identify the optimal space for the product/pallet based on the type of product, the size of the pallet, the expected shipping date of the product/pallet, or any other number of factors. In certain embodiments, a legacy system 22 at the specific location can coordinate with the processor 12 to perform these functions.

At the appropriate time for shipping the product/pallet, the processor 12 can actuate an autonomous vehicle to retrieve the product/pallet from its storage space and transport it to the loading dock of the first location (block 156). At this point, the product/pallet can optionally be transported through a portal 20 to scan the products and the pallet before it is loaded onto the transport (block 158). In one embodiment, the scan can not only record the status of the product/pallet as being loaded onto a specific truck with a specific location, but it can also be used to identify any changes to the product/pallet since the previous scan. That is, any change in the number of products/boxes on the pallet, any change to the condition of the products/boxes, or any other changes can be captured by the sensors 118 on the portal 20 and collected by the processor 12. If any such changes are unexpected, the processor 12 can trigger action by an autonomous vehicle and/or trigger an alert or notification to a user at the first location to address the situation. If no changes are detected or no actions are necessary, the system 10 notes the new status of the product/pallet as being in transit from the first location to a second location. In certain embodiments, a legacy system 22 at the specific location can coordinate with the processor 12 to perform these functions.

When the product/pallet is delivered to the second location, the product/pallet is unloaded from the transport and transported through a portal 20 to scan the products and the pallet (block 160). Thus, the scan can once again not only record the status of the product/pallet as having arrived at the second location, but also can be used to identify any changes to the product/pallet since the previous scan in a fashion similar to that described above for the previous scan. In certain embodiments, a legacy system 22 at the specific location can coordinate with the processor 12 to perform these functions.

Once the product/pallet is scanned, and if there are no actions required, the processor 12 can use the product/pallet information and the information about the second location to place the product/pallet in an available space at the second location (block 162). That is, in a fashion similar to that described above, the system 10 can use information about the layout of the first location the open spaces therein to identify an optimal space and actuate an autonomous vehicle (such as any of the vehicles disclosed or contemplated herein) to move the product/pallet to that space. Alternatively, the system 10 can coordinate with a legacy system 22 at the specific location to perform these functions. In certain implementations, the second location is the final destination of the product/pallet, so once it is placed in its designated storage space, it can be handled by the second location's legacy internal management system(s) 22. Alternatively, if the second location is the final destination, the product/pallet may simply be scanned by transporting it through a portal 20 (or via any other method) to confirm its arrival at the destination, and then the product/pallet may be removed from the system 10.

While only two locations are described in this particular example, one of skill in the art understands that the specific number of locations for any particular product/pallet can be three, four, five, or any other number of locations as the product/pallet is transported from its starting location to its final destination. At each such location, the various steps described above can be performed in a similar fashion.

As noted above, in certain embodiments, the system 10 can have information about each of the locations that the one or more products/pallets might be shipped to or from. That is, in certain implementations, the system 10 can be used to collect and maintain information about a location and the products/pallets that are stored there, including the specific location of each of the products/pallets. In one exemplary version, this inventory information is collected and maintained in the following fashion.

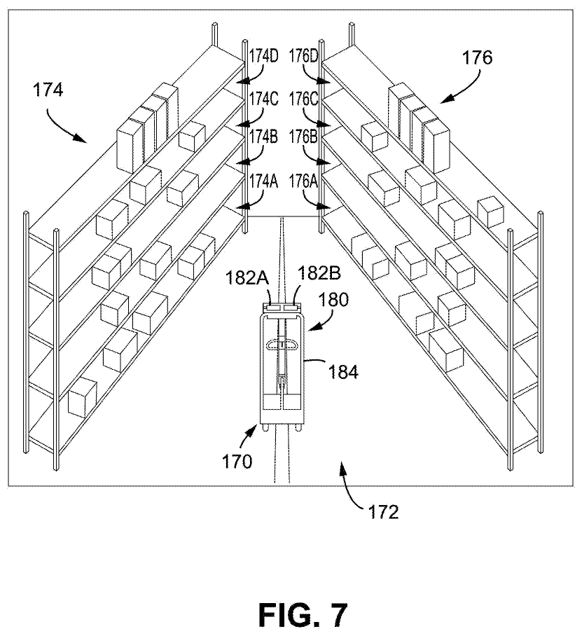

One or more autonomous tracking vehicles (such as any of the autonomous vehicles disclosed or contemplated herein, for example) can be operated to travel through the facility and capture images of items and/or empty spaces located therein. For example, FIG. 7, according to one implementation, depicts a tracking vehicle 170 traveling down an aisle 172 in a facility with shelves 174, 176 of items on both sides of the aisle 172. More specifically, in this particular aisle, the shelving 174 on the left has five levels 174A, 174B, 174C, 174D, 174E as shown, including the floor level 174A, a first shelf 174B, a second shelf 174C, a third shelf 174D, and a fourth shelf 174E. Similarly, the shelving 176 on the right has the same five levels 176A, 176B, 176C, 176D, 176E. Alternatively, any type of shelving configuration with any known number of levels is contemplated. In this implementation, the collection apparatus 180 has two digital cameras 182A, 182B attached to an extendable mast 184. Alternatively, or in addition, the collection apparatus 180 can have any other type of sensor as described in additional detail elsewhere herein.

In use, the vehicle 170 travels the length of the aisle 172 such that the cameras 182A, 182B can captured images of all the items and empty spaces on each level/shelf. In some embodiments, the vehicle 170 can make two or more passes to capture images of all the levels/shelves. Alternatively, the vehicle 170 has a mast 184 tall enough and has a sufficient number of cameras or other sensors to capture images of all of the levels/shelves along the entire length of the aisle 172. And this process can continue for each aisle and/or set of shelves in the facility until all the items and empty spaces in the facility have been imaged. Alternatively, this process can be limited to a specific aisle, set of aisles, or section of the facility for some targeted tracking for any specific purpose. As such, the vehicle 170 can identify each product/pallet in the location, identify its location, and further can identify the location of every open or empty space as well, and the information can be transmitted to the server 12 (or to a local server on a local network). Any other information about the product/pallet can also be collected and thus stored by the processor or server in the database 26 (or in a local database of a network that is connected to the system 10). In certain embodiments, the inventory data collection can be performed by the autonomous vehicle while the vehicle is also pushing/pulling carts containing products/pallets around the location for placement in appropriate spaces. Alternatively, the inventory data collection can be the sole function of the autonomous vehicle.

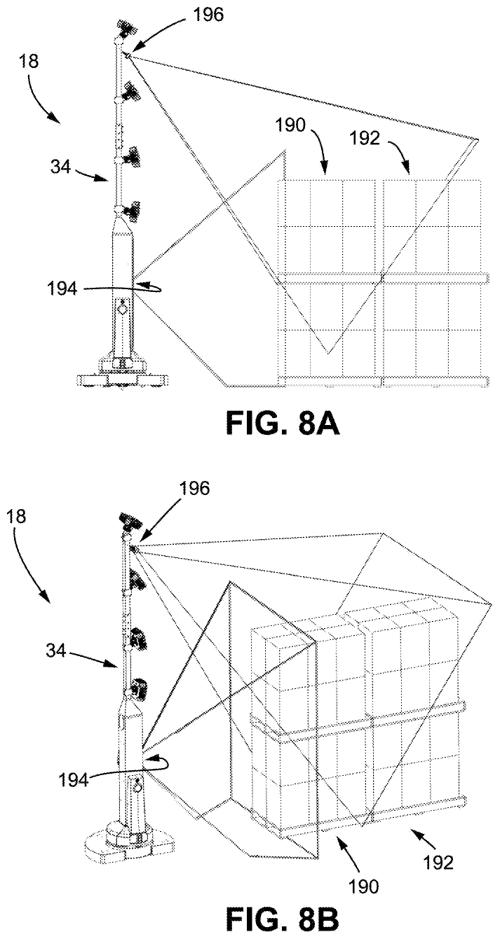

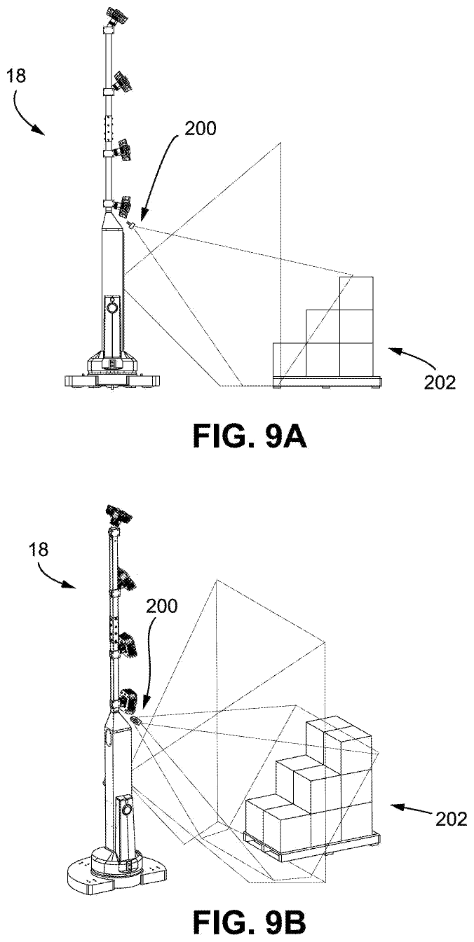

Another embodiment of an autonomous robot 18 for inventory data collection and tracking (as discussed above with respect to FIGS. 1 and 2A) and a method of collecting inventory data with the robot 18 is depicted in additional detail in FIGS. 8A-9B. The robotic device or vehicle 18 has features and functionality that allows for the collection of additional product/pallet information that other devices are unable to collect. That is, as shown in FIGS. 8A and 8B, the autonomous vehicle 18 moving along an aisle in a warehouse or other similar space having two or more rows of pallets next to the aisle can collect information about the pallets in the rows that are “behind” the row next to the aisle. That is, while other data collection vehicles/robots can only collect information about each pallet immediately adjacent to the aisle, the autonomous robot 18 in this implementation has a mast 34 that extends above the height of the uppermost pallet in the first row (the row adjacent to the aisle) 190 and has sensors 36 that can capture images of the rows of pallets disposed “behind” (on the other side of) the first row of pallets 190, including the second row 192 and any additional rows (not shown) disposed beyond the second row 192. Thus, the autonomous robot 18 can collect information about not only the first row pallets 190, but also the second row pallets 192 and any other rows beyond the second row of pallets 192. The sensor 194 on the side of the vehicle 18 can capture and collect information about the front row of pallets 190, because the first row of pallets 190 is within the field of view of the sensor 194 as shown. Further, the sensor 196 disposed near the top of the mast 34 can capture and collect information about the second row of pallets 192, because the second row of pallets 192 is within the field of view of the sensor 196 as shown.

According to the exemplary version as shown, both rows of pallets 190, 192 are stacked two pallets high. Alternatively, the rows 190, 192 can be stacked three pallets, four pallets, five pallets, six pallets, or any number of pallets high. In such embodiments, one of skill in the art understands that the autonomous robot 18 has a mast 34 that extends higher than the height of the uppermost pallet in the first row 190 such that the mast 34 has a height sufficient to allow for the sensor 196 to capture the second row of pallets 192 and any additional row of pallets in its field of view.

In one embodiment, the sensors 194, 196 can be a camera or other imaging sensor, a lidar sensor, both a camera and a lidar sensor, and/or any other type of sensor that can collect the product/pallet information.

Thus, the sensors 194, 196 capture the rows of pallets (at least the first and second rows 190, 192) in their fields of view as described above such that the sensors 194, 196 can collect information about each pallet in view (including at least the fact that such pallets are present and also including in some cases pallet identification and the like) and communicate that information to the system 10.

According to certain implementations, the robot 18 can also have sensors such as RFID readers, barcode readers, and/or any other type of sensors that can read the information on each pallet (in the form of an RFID tag, a barcode, or the like) and thus can also collect specific information about each pallet, such as the stock keeping unit (SKU) of each pallet or other such information, and communicate it to the system 10. In some embodiments, the pallet-specific information about the pallets in the second row 192 or any additional row beyond may not be captured by the RFID/barcode/reader sensors. In such cases, the pallet-specific information may already be known (and previously entered into the system 10) or can be assumed to be the same product or SKU as the pallet in the first row 190 and thus can be communicated to the system 10 as such.

In some embodiments, the pallet-specific information discussed above can be obtained from one or more machine-readable identifiers, such as a barcode, RFID tag, BLE tag, image-based identifier, lidar-detectable feature, or a combination thereof, and in some cases a tracked object can include a tag having a single machine-readable identifier, a plurality of such machine-readable identifiers, a combination of such machine-readable identifiers, etc.

Further, the autonomous robot 18 is also configured to be able to determine the number of products/boxes/cases on a single pallet and thus be able to perform a more granular inventory analysis and determine the number of products/boxes/cases (rather than just the total number of pallets) while also being able to determine the number of available spaces on that pallet for additional products/boxes/cases. That is, as shown in FIGS. 9A and 9B, the robot 18 can have a sensor 200 that is a light detection and ranging (LIDAR) device 200. In some embodiments, the robot 18 can be positioned such that the LIDAR device 200 captures a pallet 202 that is not completely full (it doesn't contain the maximum number of products/boxes/cases). In some cases, this could be because the pallet 202 has been partially picked over (like at a discount warehouse club retail outlet where consumers take cases directly from the pallet), because there weren't enough products/boxes/cases to fill the pallet, or for any other reason. In such embodiments, the system 10 can use the information captured by the LIDAR device 200 to create a digital representation (a digital “twin” or “duplicate”) of the pallet 202 by creating a point cloud representing the remaining products/boxes/cases 204 on the pallet 202. The system 10 can use the predetermined volume of the pallet (when the pallet is full) to determine the unused volume of the pallet, and thereby determine how many products/boxes/cases are “missing” how many spaces are available for additional products/boxes/cases to be added to the pallet 202.

As used herein, a digital representation or digital twin of a facility can include digital information corresponding to fixed infrastructure, mobile equipment, transient assets, open storage spaces, and other relevant features within the facility. For example, the digital representation can include one or more of dock doors, aisles, racks, shelves, bays, slots, staging areas, conveyors, portals, autonomous vehicles, manually operated equipment, pallets, cases, boxes, products, and empty spaces, together with respective locations, statuses, dimensions, conditions, and/or movement histories. In some embodiments, the digital representation is maintained in a common coordinate framework and is updated as items, equipment, or other assets move through the facility.

In some embodiments, the digital representation or digital twin can include not only the physical characteristics of the facility and its fixed infrastructure, but also transient inventory and other transient items as the transient inventory and other transient items move through the facility. For example, the digital twin can be updated to reflect items when the items arrive at a location, when the items are put away, while the items remain in inventory, and when the items are prepared for shipment or shipped from the location. In this manner, the digital twin can maintain information regarding both the physical space and the changing population of products, pallets, cases, boxes, and other items within that physical space.

In some embodiments, the system can use a plurality of different scanning technologies to build, update, or refine the digital twin and associated item records. For example, one or more autonomous vehicles, portals, carts, fixed scanning stations, or other data collection arrangements can include one or more barcode readers, one or more RFID readers, one or more Bluetooth sensors, one or more Bluetooth low energy (BLE) sensors, one or more cameras, one or more lidar sensors, or any combination thereof. In some embodiments, the system can use barcode-based data collection for items having front-facing barcodes while also using RFID, BLE, imaging, lidar, or a combination thereof to collect information from items that are not positioned for direct front-facing barcode access.

In further embodiments, one or more products, pallets, cases, boxes, or other tracked items can include a hybrid tag. For instance, a hybrid tag can include a combination of machine-readable identifiers associated with an item. As used herein, the term “machine-readable identifiers” can refer to barcodes, RFID tags, BLE tags, image-based identifiers, lidar-detectable features, and other machine-readable features associated with an item. For example, the hybrid tag can include both a barcode portion and an RFID portion associated with the same tracked item. In some embodiments, the barcode portion can be used when the item is positioned such that the barcode is visible to a camera or barcode reader, while the RFID portion can be used when the item is not front facing, is disposed behind another item, is stacked in a less accessible position, or otherwise is not conveniently readable using optical scanning alone. In this manner, the system can collect identifying information for both front-facing inventory and inventory disposed behind front-facing inventory using a combination of optical and non-optical sensing.

In some embodiments, the system can use the above-described combination of scanning technologies to create and maintain a digital twin of a physical space while also capturing transient inventory within that physical space. For example, as items are received, staged, put away, stored, picked, moved, or shipped, the system can selectively use barcode data, RFID data, BLE data, image data, lidar data, or any combination thereof to associate the items with corresponding locations in the digital twin. Thus, the maintained digital twin can reflect both the physical characteristics of the facility and the current location and status of transient inventory as that inventory changes over time.

Given that products/boxes/cases are first removed from the top pallet in a retail or other setting, the robot 18 can be configured to capture the top pallet in the field of view of the LIDAR camera 200. As such, it is understood that, in certain embodiments, the camera 200 can be disposed at any location on the robot 18—including the mast 34—in order to be able to capture the top pallet in its field of view and thus be able to perform the process as described herein to determine the number of products/boxes/cases on that top pallet.

The system 10 may then update its inventory information with the correct number of products/boxes/cases on the pallet 202 and thereby be able to calculate the total number of products/boxes/cases in the location. In certain embodiments, the system 10 can also (or instead) update the local warehouse management system 22 coupled to the system 10 for that particular location. Thus, a detailed inventory of that product may be computed at a more granular case level and reported by the system 10. This process may be a continuous process such that the point cloud and associated annotations are constantly evolving and creating up to the hour updates on inventory within the warehouse. In some embodiments, a color or other distinguishing feature (e.g., size, shape, material, and/or a combination or other characteristic) of any given pallet may also be observed such that an inventory of the pallets themselves (i.e., the manufacturer or owner of the empty pallet itself) may be tracked in real-time or nearly real-time. Thus, the LIDAR device 200 (and any additional LIDAR devices at any location on the robot 18) can be used to create a digital representation of the entire location (warehouse, distribution center, etc.) that can be accessed from the system 10 by any user, including the owner/manager of the location and/or the owner/manager of any products/boxes/cases/pallets located at that location, thereby allowing for detailed tracking of not only the number of pallets/products/boxes/cases, but also the location of each, the layout, and the status of each pallet.

In other embodiments, the system 10 can use the lidar device 200 in combination with the camera imaging device 196 (as shown in FIGS. 8A and 8B) to determine the total number of cases in an aisle or an entire location. For example, the system 10 may direct the robot 18 to approach a stack of pallets (such as, for example, the stack in row 190 as shown in FIGS. 8A and 8B) that is 3 pallets across, 4 pallets deep, and stacked on shelves reaching up to 4 pallets high (although it should be known that the numbers in the stack of pallets may differ from this non-limiting example without deviating from the scope of the disclosure). The camera 196, using one or more of the strategies and/or elements from one or more of the embodiments above, may take a total inventory of the pallets of a given SKU on the floor, and compute a total number of cases that would be available if each were in the full state. In one exemplary embodiment, the top pallet on the top shelf may reach as high as about 35 feet and the camera 196 is able to reach as high as about 38 feet to read a barcode on each of the pallets to identify the particular SKU in each stack. Alternatively, as noted above, the stack of pallets can have any height, and the robot 18 can have a height that is greater to allow for operation of the robot 18 as described herein.

In some embodiments, the system 10 can use the information collected by the sensors on the robot 18 (including any of the sensors described above, including the LIDAR camera 200, the sensor 194, the LIDAR camera 196, and any other sensor or reader) to calculate the total inventory of any particular product, any particular type of product, any particular set of pallets, and/or the total inventory of products/boxes/cases in the location in question. In some embodiments, the system 10 can store the information as it is received by the robot 18 in real-time or nearly real-time in the database 26.

It is understood that the autonomous inventory collection devices/vehicles described above and the methods used by those devices/vehicles are also described in additional detail in U.S. patent applications Ser. No. 16/928,993, Ser. No. 18/600,879, and/or 63/756,513, all of which are incorporated by reference above.

As noted above, the various system 10 embodiments disclosed or contemplated herein can allow for access to specific, limited information by various third parties, companies, or other entities who have an interest in the specific supply chains, locations, and/or products being tracked and managed by the systems 10 herein. That is, one or more of the software programs/modules provided with the system 10 can provide configurable levels of access for any user accessing the system 10 based on the user's role, such that the user can only access the functionality of the system and the information therein based on that user's role and the limited access provided to them. Such third parties could include the owner/manager of a particular location (warehouse, distribution center, etc.), the owner/manager of a specific set of pallets/products being shipped along the supply chain, etc. Thus, each such third party or user can access the system 10 via a client computer 14 via a unique identification created for the system 10 such that the identification provides specific, limited access to that user that provides solely the information relevant to the user. As such, the user may be required to create a unique identification and password in advance, and then the limited access level will be created based on the identity of the user. As such, any user with products/boxes/cases/pallets being tracked/managed by the system 10 can access the system 10 to view any information about those products/boxes/cases/pallets, including current location (including exact location in the warehouse/DC/etc.), shipping history, number of products/boxes/cases/pallets, condition, or any other information collected by the system 10. Further, any location owner/manager/user can access any information about the specific location, the total number of products/boxes/cases/pallets therein, the specific location of any specific product/box/case/pallet within the location, the number and location of any empty spaces in the location that can receive pallets, etc. In certain embodiments, the various users may be provided with the digital representation of the location of interest or the relevant area within the location of interest. As such, the unique, limited access functionality of the various system 10 embodiments herein allows any user to purchase and access specific modules of the system 10 that are relevant to their use of/involvement in the supply chain.

As such, the system 10 can be used by any user or any entity as a supply chain tracking and managing system for any one or more of the user's or entity's products/boxes/cases/pallets along a supply chain of any size. That is, the system 10 can be used by a user/entity for a supply chain within one company or even just a portion of a company/supply chain. For example, the system 10 can be used by a manufacturing facility, a warehouse, or a 3PL to track a specific item to the end user. Alternatively, the system 10 can be used by a logistics company or other supply chain management entity to track multiple products/cases/boxes/pallets across an extensive, complex supply chain with multiple stops. In addition, in further embodiments, the system 10 can be used to link together multiple users/entities for the tracking of a single product/box/case/pallet or multiple products/boxes/cases/pallets as it passes from one entity to another along the supply chain.

As discussed above, the system 10 embodiments herein can utilize the various imaging devices on the various autonomous vehicles/robots connected to the system 10, along with LIDAR technology, to create digital representations or duplicates of any space, area, or entire location along the supply chain through which any of the various products/boxes/cases/pallets being tracked. In other words, the system 10 allows for high level granularity in the tracking of those items by creating a digital representation of a specific area/location and all of the pallets/products/boxes/cases therein. This allows for close and accurate monitoring and management of each product, each case, and each pallet along the supply chain, as described elsewhere herein. Further, it allows for each user with limited access as described above to be able to view the relevant digital representations that capture their products/cases/pallets/locations of interest. Further, it allows the system 10 and/or any legacy system 22 to utilize a digital representation (or the related information) to determine the optimal empty space for placing a pallet when it arrives at a location and actuate a relevant autonomous vehicle (such as a forklift, for example) at that location to move the pallet(s) to that space. In addition, the system 10 can have a graphic user interface or digital portal that is accessible via a client computer 14 such that each user can readily interact with the system 10 via the GUI, and the digital representations can be incorporated into such GUI. Further, the autonomous vehicle can also be configured to report the storage location of the pallet(s) to the system 10 (or legacy system 22) such that the exact location is noted and tracked.

Thus, the various embodiments herein allow a single system 10 to track and manage any product being shipped along a supply chain from the manufacture or origins of the product to its final destination, and can use various autonomous vehicles/robots/devices during the process. In other words, any embodiment of the systems described above can be used to track and manage the movement of at least one product in a supply chain such that the product can be tracked and transported from its point of origin to its destination, along with any distribution center or other location at which the product is stored or otherwise retained therebetween. That is, the various system implementations herein can utilize one or more devices or systems (including any autonomous devices or vehicles) at each location (including the point of origin, the final destination, and any location therebetween) to track and/or transport the one or more product from the point of origin to the final destination. Further, the system 10 can be connected with the legacy systems of the locations along the supply chain, thereby allowing for seamless sharing and use of information to allow for tracking and management across the entire supply chain, instead of just discrete locations therein.

In some embodiments, for example, in implementations such as those illustrated generally in FIG. 1 or other figures or embodiments discussed herein, the system can interface with one or more warehouse management systems, enterprise resource planning systems, material requirements planning systems, or other site-specific software platforms while also maintaining a representation of the physical space of the facility and the assets located therein. In such embodiments, the system can correlate information identifying a particular product, box, case, pallet, vehicle, or storage location with a physical location within the facility such that the information is usable not only by a software system or operator, but also by one or more autonomous devices operating in the physical environment. Thus, rather than relying solely on a system-designated location identifier, the system can associate one or more items and one or more vehicles with a physical position within the facility.

In certain embodiments, the system can create and maintain a digital representation of the facility that serves as a common source of information regarding fixed infrastructure, mobile equipment, open storage spaces, and transient assets moving through the facility. The digital representation can be updated using information collected by one or more autonomous vehicles, scanning devices, portals, or other sensors described herein. This can include, for example, sensing arrangements such as those illustrated generally in FIGS. 7-9B and/or, for example, vehicles or devices such as those illustrated generally in FIGS. 2A-5D, in some embodiments. In this manner, the system can provide a single version of truth for the facility that harmonizes information from multiple software platforms, multiple autonomous vehicle and/or device systems, and multiple data collection sources and that can be used to identify the location of items and the location of different autonomous or manually operated equipment (including equipment operated via different systems) within the same physical space.

In some embodiments, and using sensing arrangements such as those illustrated generally in FIGS. 2A-C, 3A-C, 4A-B, 5A-D, 7, 8A-B, and 9A-B, the digital representation can store, or can be used to derive, a physical location for each of a plurality of items, storage positions, and autonomous or manually operated vehicles within a common coordinate framework, such as a shared set of x, y, and z coordinates for the facility. Thus, a product, pallet, case, box, or other asset can be associated not only with a warehouse system identifier or nominal storage designation, but also with a physical position that can be used by one or more autonomous devices navigating within the facility. In further embodiments, the same autonomous inventory vehicle or other scanning device used to collect inventory information can also collect data usable to create, update, or refine the digital representation of the facility, such that inventory monitoring and digital twin maintenance can be performed together during routine operation of the system.

In yet another alternative, any of the device and/or system embodiments herein can also be used to coordinate and orchestrate multiple different autonomous robots and other types of autonomous vehicles (including those operating via different systems) in a particular environment, such as a warehouse, retail space, or any other environment contemplated herein. Currently, separate companies and manufacturers of autonomous devices, vehicles, and robots use separate navigation tools and systems such that autonomous devices from different companies or manufacturers cannot operate in the same space without risking collisions and other problems arising from the fact that they are not communicating (and typically cannot communicate) with each other as to their location or other information. As a result, if a prospective autonomous mobile robot (AMR) adopter or user wants to buy best-in-class autonomous devices or vehicles for each task in a manufacturing, warehouse, or other similar environment, some way to orchestrate how those different AMRs work together must be found. This cannot be done easily with known systems, because they all use their own navigation system based on their own maps of the facility, which can vary based on the date they were created.

In certain embodiments herein, for example, in implementations using an architecture such as that illustrated generally in FIG. 1 and/or other architectures, any of the systems described herein can incorporate software that can create a digital twin of the location or facility that can serve as the single reference point or navigation map for not only the various autonomous vehicles of any system described above, but also provide coordination and orchestration of other AMR robots and autonomous vehicles or devices and their systems. As a result, all the various autonomous vehicles in the space can use the same map with the same established x, y, and z coordinates. The software in any system embodiment herein can provide a single map reference that can be centrally managed and updated, rather than having each separate robotic system needing to update when changes are made to the facility. This also makes it more efficient to coordinate or orchestrate the movement of different AMR systems. It can be understood as a coordination or orchestration layer in the technology stack.

In one embodiment of the software and its use within any system implementation as disclosed or contemplated herein, with both autonomous or manually operated equipment used in each individual stage or all stages, the system first creates a digital twin map of the facility that can be maintained by the system or at least one device thereof, using an autonomous vehicle or the forklift-mounted scanning device or any other such device, including, for example, devices such as those illustrated generally in FIGS. 2A-C, 3A-C, 4A-B, 5A-D, 7, 8A-B, and 9A-B, that can continuously update the digital twin map of the facility. This map then serves as the facility system of record for all autonomous vehicles and systems that might be used at that location. Or, alternatively, in the case of a multi-site enterprise, the digital twin maps of all of the facilities can serve as the facility system of record. The software as contemplated herein can build and maintain the digital twin maps for such purposes.

For example, the software incorporated into any of the systems contemplated herein can be used for an item or shipment receiving process. In some embodiments, aspects of such a process can correspond generally to portions of the workflow illustrated in FIG. 6. That is, in one embodiment, the process can occur as follows.

First, a truck or other vehicle can arrive at the facility (for example, at a specific loading dock). An autonomous device can be autonomously dispatched by the system software to the dock to scan the arriving items, with the travel of the device or vehicle being tracked by the system. At the same time, in some embodiments, the software can alert an autonomous forklift, pallet mover, or other device, or a human-operated manual device or system, that there are items at the dock to be unloaded. That device moves to the dock while being tracked by the site-specific software as well.

The pallet or items are unloaded and scanned by the sensors on the autonomous robot or vehicle, a pallet sensor, or any other collection device as contemplated herein, for example, using a portal arrangement such as that illustrated generally in FIGS. 5A-D. That scan captures the condition and any item data, such as pallet license plate information, individual bar codes, RFID tags, or BLE tags, and reports those data to the software system. The successful receipt of the delivered items can be configured to be shared with the supplier or any other entity that sent the items.

With the data collected as described above, the software can record the item as received and assign locations to the items or pallet of items. That could be a number of categories, such as, for example, items to be staged for subsequent put away, items to be moved to an identified put away location, and/or items that were damaged and set aside for resolution or return. Alternatively, the items can be placed into any other known category or categories that might be useful at a particular location.

In further embodiments, and using transport equipment such as that illustrated generally in FIGS. 2B-C, 3A-C, 4A-B, etc., the identified destination for a received item need not be the final storage position of the item. For example, the system can direct an autonomous pallet mover, conveyor, or other transport device to move the item to a staging area or put away zone within the facility, after which a human-operated forklift, an autonomous forklift, or other equipment can move the item from the put away zone to a final storage location. In some embodiments, the system can receive additional scan data or confirmation data when the item is placed in the final storage location so that the digital twin and associated inventory records reflect the final position of the item within the facility.

The scanning and other data collection functions described herein are not limited to any particular mounting arrangement or equipment type. In some embodiments, one or more sensors can be mounted on, carried by, or otherwise associated with an autonomous vehicle, a manually operated vehicle, a forklift, a pallet mover, a cart, a portal, a conveyor-adjacent structure, a dock-adjacent structure, or another mobile or stationary support. In some embodiments, a sensor package can be used with equipment that operates fully autonomously, semi-autonomously, manually, or in different modes at different times. Accordingly, the disclosed receiving, shipping, inventory, digital-twin maintenance, and safety-monitoring functions can be carried out using any suitable combination of mobile and/or fixed data collection arrangements disclosed or contemplated herein.

At this point, for example using the coordinated system architecture illustrated generally in FIG. 1, any system embodiment herein can then coordinate or orchestrate with other equipment to move the item as required, including equipment directly coupled to the system or other third-party equipment that can be coordinated via the system and the use of the location map. In a specific example, an autonomous pallet mover can be used to move the item from a staging area to a put away location that is identified by the software system. It could be staged in an aisle or a zone for a forklift, autonomous or human operated, to place it in a bulk storage location, such as an empty slot in a warehouse rack system. Because the system is tracking the status of all of these details in the digital twin, the software system can coordinate, direct, or orchestrate the movement of the various pieces of human-operated or autonomous equipment to complete all the tasks required for receiving, staging, put away, and inventory updates. Further, in certain embodiments, the system can also report the status of those tasks in a centralized dashboard or user interface that can be configured to provide role-specific access and views.

These same capabilities can also be used for an order fulfillment process. In one exemplary embodiment, an order to be fulfilled or picked is entered into the software, typically from a client's existing system. The order is sent to an autonomous vehicle or robot with the x, y, and z coordinates provided for the item to be picked. The system or software then directs a human or autonomous vehicle or device to that location and the item, and the quantity is scanned, picked, and recorded. The autonomous robot can then scan the item as it is picked and placed on an autonomous platform or a trailer or cart attached to an autonomous platform. That scanned pick can then be deducted from the quantity listed for the location from which the item was picked. In some embodiments, the lowest level is tier 1 on the floor and serves as the pick level, which results in full pallets at that level being depleted by each pick. The autonomous vehicle or the scanning device can be used, for example, using sensing arrangements such as those illustrated generally in FIGS. 8A-B, 9A-B, etc., to calculate the specific number of items remaining on a partial pallet. This scan-as-picked function matches the current manual process, but the scan is now done by a robotic scanning system.

The picked items are placed on a cart or a pallet, for example, on a cart such as that illustrated generally in FIGS. 2B-C, 3A-C, 4A-B, etc., and the software system directs the autonomous vehicle, robot, or operator to the next pick location until the full order is picked. The software system then sends the cart or pallet to the next step in the process, which is typically a wrapping station that wraps the items for shipping on a pallet.

The full order picked pallet is then sent to a staging area to be loaded on an outbound trailer. As illustrated generally in FIG. 6, and optionally using a portal arrangement such as that illustrated generally in FIGS. 5A-D, when it is time to load the trailer, the software system can dispatch a human or autonomous device to load the trailer. Further, the system can also simultaneously dispatch an autonomous vehicle or other autonomous scanning system to document load time, condition at the time of shipment, and all the details associated with a full-order or partial-trailer order. When the load process is complete, the software system can confirm date, time, and condition of the shipment and alert both the party shipping the load and the party receiving the load of the information.

In summary, in implementations such as those illustrated generally in FIG. 1, the various system embodiments herein can provide process management and coordination of various autonomous vehicles, robots, and/or scanning systems at a single location or across two or more facilities operated by a single enterprise or across the supply chain. More specifically, the system allows for coordination and orchestration of multiple different autonomous vehicles, devices, and/or systems regardless of the separate origins of those vehicles, devices, and systems and regardless of whether they are intended to use solely their own navigation systems. As noted above, the system embodiments herein can have at least one device or vehicle, such as a robot or a scanning tower or device, that is continuously scanning inventory and updating the digital twin map, and thereby maintaining the accuracy thereof, which is then provided to all autonomous vehicles, devices, robots, and/or systems at the location, including third-party vehicles, devices, robots, and/or systems. Thus, the shared digital twin platform enables coordination and orchestration of the system's autonomous vehicles and scanning devices, autonomous vehicles, robots, and/or systems supplied by others, or human operators, in any combination.

In some embodiments, the maintained digital representation, map, or related location data can be provided to additional autonomous platforms that are not originally used to create the digital representation, including third-party robots, autonomous vehicles, humanoid robots, or other automated equipment that operates within the facility. In this manner, the maintained digital representation can serve as a common spatial reference for multiple different robotic or automated systems, even if such systems would otherwise rely on separate native maps.

This combination of a consistently maintained digital twin map of the facility and the automation of the receiving and shipping process using AMRs or a combination of AMRs and human operators is built, enabled, and maintained by the scanning capabilities designed into the various autonomous vehicles, robots, portals, carts, and other scanning devices disclosed or contemplated herein, including, for example, the autonomous data collection device of FIG. 2A, the data collection carts of FIGS. 2B-2C, the sensor-equipped autonomous vehicles of FIGS. 4A-4B, the product data collection portals of FIGS. 5A-5D, the tracking vehicle of FIG. 7, the autonomous inventory robot embodiments of FIGS. 8A-9B, etc. This software and hardware approach can provide visibility and transparency of supply chain operations in a single facility, multiple facilities managed by the same client, or additional supply chain partners.

In some embodiments, the chain-of-custody information can be maintained for an item throughout the time the item is present at the facility, from receipt through storage, picking, staging, loading, and departure. The chain-of-custody information can include one or more scans, images, timestamps, condition determinations, quantity determinations, and location updates associated with the item at different stages of handling. In this manner, the system can maintain a location-aware historical record for the item that reflects not only item-related data collected at different times, but also where in the facility the item was located when the corresponding event occurred.

In further embodiments, information maintained in the digital twin and associated databases can be queried, analyzed, or processed to identify patterns or conditions within the facility or across multiple facilities. For example, the system can be used to identify recurring congestion locations, repeated inventory discrepancies, utilization of storage space, or trends associated with item age, expiration-related information, movement frequency, or dwell time. In some embodiments, the digital representation can also be exported to, imported from, or otherwise used with computer-aided design data, facility-layout data, or other building-information data so that fixed infrastructure, mobile equipment, and transient assets can be represented within a common digital environment. In still further embodiments, the collected data can be processed using one or more analytical or machine-learning techniques to support process optimization, exception identification, or decision support.

In further embodiments, and subject to any desired permissions, access rights, or data-sharing rules, information collected from one or more facilities can be aggregated and used to build, train, refine, or operate one or more analytical models, machine-learning models, or other data-driven tools relating to interior physical spaces. Such models can be used to answer queries, identify patterns across facilities, predict congestion, identify misplaced, aging, or expiration-sensitive inventory, recommend storage locations, support route planning or task allocation, detect exceptions or safety conditions, or otherwise support management of fixed infrastructure, mobile equipment, and transient assets within one or more facilities.

In further embodiments, and using, for example, portal arrangements, autonomous data collection devices, sensor-equipped autonomous vehicles, robots, carts, and/or related process flows of the type illustrated generally in FIGS. 2A-2C, 3A-3C, 4A-4B, 5A-5D, and 6, the receiving and shipping functions described above can be carried out using a fixed portal, a mobile portal, an autonomous robot or vehicle dispatched to a loading dock or unloading area, a scanning device positioned adjacent to a conveyor, or any combination thereof. For example, rather than requiring fixed scanning infrastructure at each dock door, the system can dispatch an autonomous data collection vehicle to a selected dock door to scan pallets, boxes, or other items as the items are unloaded from an inbound vehicle or moved along a conveyor. The resulting scan data can include identifier information, quantity information, condition information, and time-of-receipt or time-of-shipment information. In some embodiments, the system can store such information as part of a chain-of-custody record associated with the item and with the physical location of the item within the facility.

In further embodiments, information collected during receipt, storage, picking, loading, and shipment, for example, in workflows of the type illustrated generally in FIG. 6 and using any of the portals, autonomous vehicles, robots, carts, sensors, or other collection arrangements disclosed herein, can be selectively shared with one or more external entities, such as a supplier, customer, carrier, consignee, or other supply-chain participant having appropriate access rights. Such shared information can include confirmation that an item was received, its observed condition at a particular time and place, its departure from a facility, or other chain-of-custody and status information associated with the item. In this manner, the system can provide location-aware visibility for one facility, multiple facilities operated by a common enterprise, or multiple authorized participants across a supply chain.

In additional embodiments, using sensing systems, autonomous tracking vehicles, autonomous inventory robots, portals, and other data collection arrangements of the type illustrated generally in FIGS. 2A, 3A-3C, 4A-4B, 5A-5D, 7, 8A-8B, and 9A-9B, the system can use the same continuously updated digital twin map and the same scanning infrastructure to confirm, on a repeated basis, that items remain in their expected locations, that designated storage spaces remain open or occupied as expected, and that inventory information remains current. The system can use such information to generate reports regarding quantity, location, age, or expiration-related information for one or more items, pallets, or product groups and to identify inventory that is old, stale, or otherwise requires attention. Further, in some embodiments, the sensors and imaging devices described herein can also be used to detect safety or compliance conditions within the facility, including rack damage, pallet overhang, structural deflection, improper stacking, tipping conditions, or other out-of-compliance conditions, and the system can generate an alert, notification, image set, or report in response thereto.

In some embodiments, using repeated scanning and location-confirmation operations of the type illustrated generally in FIGS. 7, 8A-8B, and 9A-9B, and optionally further using other sensing and data collection arrangements disclosed herein, the repeated scanning and location-confirmation functions described herein can reduce or replace at least a portion of manual inventory verification activities, including periodic cycle counts and manual inspection of elevated storage locations. For example, the system can repeatedly traverse aisles and capture item-identifying data, location data, and open-space data for storage positions at multiple heights within a facility, thereby reducing the need for personnel to manually inspect rack locations using handheld scanners or lifting equipment. In this manner, the system can maintain more current inventory and location information on a more frequent basis than would be practical using manual verification alone.

In further embodiments, the repeated scanning, location-confirmation, and data-update functions described herein can be implemented using any suitable combination of autonomous vehicles, portals, robots, carts, fixed sensors, mobile sensors, or other data collection arrangements disclosed or contemplated herein. Information collected through such repeated scanning operations can be used not only for inventory verification, but also for updating the digital twin, identifying open storage locations, confirming item movement and placement, detecting exceptions or safety conditions, supporting receiving and shipping operations, and maintaining more accurate facility-wide visibility regarding items, equipment, and available space. Accordingly, the scanning, tracking, and location-management features described herein can be incorporated into a wide range of system implementations and operational workflows.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1 ½, and 4 ¾. This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

What is claimed is:

1. A supply chain tracking and management system comprising:
(a) a processor connected to a network;
(b) a database connected to the processor;
(c) at least one client computer connected to the processor via the network;
(d) at least one autonomous inventory tracking vehicle at each location connected to the processor;
(e) at least one autonomous product transport vehicle at each location connected to the processor;
(f) at least one legacy management system at each location connected to the processor; and
(g) at least one data collection portal at each location connected to the processor, wherein any product or pallet shipped through a supply chain can be tracked and managed from its point of origin to its final destination via the system.

2. The system of claim 1, wherein the processor is configured to create and maintain a digital representation of a facility.

3. The system of claim 2, wherein the digital representation comprises a digital twin map that serves as a single version of truth for the facility.

4. The system of claim 2, wherein the digital representation stores a physical location of a tracked asset and a vehicle within a common coordinate framework.

5. The system of claim 4, wherein the common coordinate framework comprises shared x, y, and z coordinates for the facility.

6. The system of claim 5, wherein the processor is configured to provide the shared x, y, and z coordinates to the autonomous inventory tracking vehicle and the autonomous product transport vehicle as a common spatial reference.

7. The system of claim 6, further comprising an additional autonomous platform connected to the processor, wherein the processor is configured to provide the common spatial reference to the additional autonomous platform.

8. The system of claim 2, wherein the autonomous inventory tracking vehicle is configured to collect, from one or more machine-readable identifiers associated with tracked items, data usable to update the digital representation during routine inventory operation.

9. The system of claim 8, wherein the autonomous inventory tracking vehicle is configured to collect identifying information from front-facing inventory and from inventory disposed behind the front-facing inventory.

10. The system of claim 1, wherein the data collection portal comprises a mobile data collection portal configured to be positioned at a selected dock-side location to scan a product or pallet during unloading.

11. The system of claim 1, wherein the processor is configured to maintain a location-aware chain-of-custody record for the product or pallet from receipt to departure.

12. The system of claim 11, wherein the processor is configured to selectively share at least a portion of the location-aware chain-of-custody record with an authorized supply-chain participant.

13. The system of claim 1, wherein the processor is configured to analyze information maintained in the database to identify an inventory condition requiring attention.

14. A system for coordinating autonomous equipment in a facility comprising:
(a) a processor connected to a network;
(b) a database connected to the processor;
(c) at least one client computer connected to the processor via the network;
(d) at least one autonomous vehicle in the facility connected to the processor;
(e) at least one data collection device in the facility connected to the processor; and
(f) software executed by the processor and configured to create and maintain a digital twin map of the facility in a common coordinate framework based at least in part on data collected within the facility, and to provide the digital twin map as a common spatial reference for the at least one autonomous vehicle within the facility.

15. The system of claim 14, wherein the digital twin map serves as a single version of truth for the facility.

16. The system of claim 14, wherein the common coordinate framework comprises shared x, y, and z coordinates for the facility.

17. The system of claim 14, wherein the at least one data collection device is configured to collect, from one or more machine-readable identifiers associated with tracked items, data usable to update the digital twin map during operation in the facility.

18. A method of tracking a product along a supply chain, the method comprising:
collecting information about the product at a first location via a first data collection portal, wherein the information comprises product information, pallet information, and location information;
shipping the product to a second location;
collecting information about the product at the second location via a second data collection portal;
actuating an autonomous device to transport the product to a space at the second location;
actuating the autonomous device to later transport the product from the space to a loading dock at the second location;
collecting information about the product at the second location via the second data collection portal;
shipping the product to a third location;
collecting information about the product at the third location via a third data collection portal; and
actuating an autonomous device to transport the product to a space at the third location.

19. The method of claim 18, further comprising creating and maintaining a digital twin map for at least the second location, the digital twin map storing a physical location of the product within a common coordinate framework, wherein the digital twin map is updated using data obtained from one or more machine-readable identifiers associated with the product.

20. The method of claim 18, further comprising maintaining a location-aware chain-of-custody record for the product along the supply chain based on the collected information.
